(19) United States
(12) Patent Application Publication
(10) Pub. No.: US 2012/0113096 A1
(43) Pub. Date: May 10, 2012

(54) MEDICAL 3D VISUALIZATION

(75) Inventor: Andrew Estrada, Escondido, CA (US)

(73) Assignee: SONY CORPORATION, Tokyo (JP)

(21) Appl. No.: 13/098,311

(22) Filed: Apr. 29, 2011

Related U.S. Application Data
(60) Provisional application No. 61/411,169, filed on Nov. 8, 2010.

(51) Int. Cl. G06T 15/00

(52) U.S. Cl. 345/419

(57) ABSTRACT

The present invention relates to a method and apparatus for use in displaying a three-dimensional (3D) image representation of one or more three dimensional surface structures. More specifically, the present invention provides a method and apparatus by which data corresponding to one or more three dimensional object surfaces may be rendered to create a 3D display. In particular, this invention involves a method for rendering 3D object data into a plurality of 2D image segments or “image tiles” for use in displaying an auto-stereoscopic 3D image.

This application claims the benefit of U.S. Provisional Application No. 61/411,169, filed Nov. 8, 2010, which is incorporated herein by reference.

### FIELD OF INVENTION

The present invention relates to a method and apparatus for use in displaying image data. In particular, this invention involves a method for rendering three-dimensional (3D) object data into an array of two-dimensional (2D) image segments or “image tiles” for use in producing an auto-stereoscopic 3D image.

### BACKGROUND OF THE INVENTION

Techniques for use in producing images representative of three dimensional (3D) objects are of use in the medical industry, for example, with respect to magnetic resonance imaging (MRI) applications wherein three-dimensional scatter data is collected and used to produce images of a 3D region. The three-dimensional scatter data comprises multiple image layers. Data collected using magnetic resonance imaging (MRI) techniques may correspond to scatter values such as a measurement of magnetic field gradients throughout the object being scanned.

Traditionally, three-dimensional scatter data (e.g. MRI data) is presented to a viewer in the form of multiple two-dimensional (2D) “slice images”—that is, as a series of 2D images wherein each image is taken from a “slice” along the third-dimensional axis. Although the process of generating slice imagery from 3D object data was a major breakthrough in computer-aided tomography, due to the 2D nature of the resulting series of 2D images, many visual features of the 3D object data are lost, e.g. the series of 2D images do not offer the viewer any perception of depth, and cannot be visually “rotated” by the viewer, so as to adjust a 3D point of view.

### BRIEF SUMMARY OF THE INVENTION

Several embodiments of the present invention answer the above and other needs by providing a method and apparatus for rendering a 3D image generated from 3D object data.

One embodiment the present invention comprises an auto-stereoscopic display apparatus which further comprises a curved display surface disposed around the curved outer surface, the curved display surface comprising a plurality of light emitting elements; a plurality of light emitting elements, wherein the plurality of light emitting elements are grouped into a plurality of tiles; and a microprocessor electrically coupled to the plurality of light emitting elements wherein the microprocessor is configured to cause the display of at least two images on at least two of the plurality of tiles to produce a plurality of image tiles.

In another embodiment, the present invention encompasses a method comprising the steps of: receiving object data representing a three-dimensional object, wherein the object data comprises a plurality of voxel values; extracting surface data from the received object data wherein the surface data represents one or more surface structures of the three dimensional object; generating a plurality of image tiles from the surface data for each of the one or more surface structures of the three-dimensional object, and displaying one or more of the image tiles for one or more of the surface structures, wherein the displaying further comprises displaying the one or more of the images tiles around a curved display surface.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure:

FIG. 1 is a perspective view of an auto-stereoscopic display apparatus according to one embodiment;

FIG. 2A is front perspective view of the auto-stereoscopic display apparatus of FIG. 1;

FIG. 2B is a left perspective view of the auto-stereoscopic display apparatus of FIG. 1;

FIG. 2C is a right perspective view of the auto-stereoscopic display apparatus of FIG. 1;

FIG. 3A is a top perspective view of the auto-stereoscopic display apparatus of FIG. 1;

FIG. 3B is a bottom perspective view of the auto-stereoscopic display apparatus of FIG. 1;

FIG. 4 depicts a series of voxel elements;

FIG. 5 illustrates a three-dimensional surface rendered into voxel elements;

FIG. 6 depicts a curved display surface according to some embodiments of the present invention; and

FIG. 7 is a flow diagram of the steps for carrying out a method according to one embodiment of the present invention.

### DETAILED DESCRIPTION

Reference will now be made in detail to certain embodiments of the present disclosure, examples of which are illustrated in the accompanying figures. It is to be understood that the figures and descriptions of the present disclosure included herein illustrate and describe elements that are of particular relevance to the present disclosure, while eliminating, for the sake of clarity, other elements found in typical two-dimensional display systems.

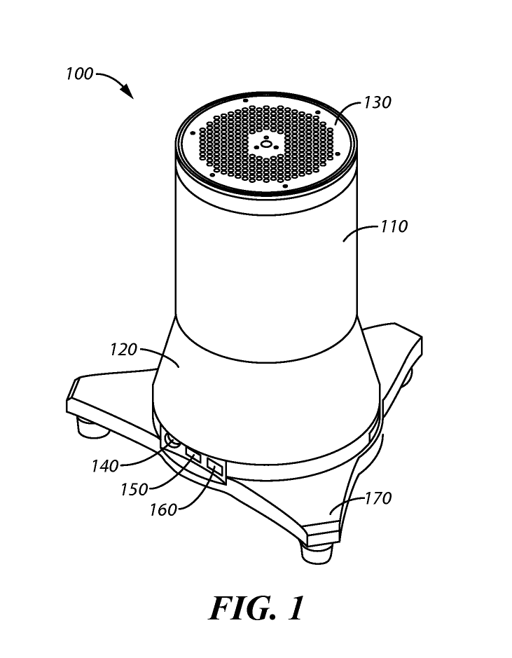

FIG. 1 illustrates a perspective view of an auto-stereoscopic display apparatus 100 according to one embodiment of the invention. Depicted in FIG. 1 are: a display 110, a front cover 120, a top cover 130 a power input 140, a video input 150, a video output 160 and a foot 170.

In one preferred embodiment, the display 110 is mechanically cooperated with the front cover 120 and the top cover 130. The front cover 120 is also mechanically cooperated with the foot 170 which provides physical support for the upright positioning of front cover 120 and the display 110 of the auto-stereoscopic display apparatus 100.

As depicted in FIG. 1, the display 110 forms a cylindrical shape about the auto-stereoscopic display apparatus 100; however, in alternative embodiments the display 110 may be configured to form essentially any three dimensional shape having a curved outer surface. In preferred embodiments, the display 110 is comprised of a plurality of light emitting elements (not shown). In some embodiments the display 110 may be comprised of essentially any type of display screen device, including, but not limited to LED, LCD, plasma and projection display devices. The display 110 itself may also be of essentially any dimension or color depth; however, in at least one preferred embodiment the panel of the display 110 has a pixel dimension of 96×128 (H×V) with a 24 bit color depth.

In preferred embodiments of the invention, the display 110 further contains a microprocessor (not shown) as well as one or more memory modules. In one preferred embodiment, the memory module may comprise one or more flash memory devices; however, the memory module may be comprised of essentially any tangible memory means such as magnetic or optical media. In preferred embodiments, the power input 140, video input 150, video output 160 and memory module are all electrically coupled to the microprocessor.

In practice, power is delivered to the auto-stereoscopic display apparatus 100 (as well as the microprocessor and memory modules) via the power input 140 to enable the display 110 of one or more images on the display 110. In preferred embodiments, the auto-stereoscopic display apparatus 100 will display a spinning two-dimensional (2D) array of 2D images on the curved display surface of the display 110, such that different images in the array (i.e. different “image tiles”) will be displayed at different relative angular positions around the curvature of the display 110 at a particular instant in time. In preferred embodiments, each displayed image tile represents an image projection of a 3D object surface taken from a particular angle. By way of example, in one preferred embodiment, 360 total image tiles will be displayed around the display 110, with each adjacent image tile separated by a one-degree angle of separation, such that the resulting image display comprises the full circumference of the display 110. In this display configuration, the image projected in each respective image tile will be displayed for an instant in time equal to 1/360^{th} of a frame duration (such that 360 image tiles may be displayed within each given frame). However, in other embodiments, a greater or lesser number of image tiles may be displayed, depending on various factors, including but not limited to the desired angle of the display 110 and the desired frame rate.

Additionally, in preferred embodiments, the display of each image tile around the display 110 will occur in a manner wherein each image tile is only visible within a specific angular field of view. For example, in one preferred embodiment, wherein adjacent image tiles are separated by a one-degree angle of separation, each displayed image tile is only be visible within a single 1 degree field of view. When displayed in this manner, a viewer's left and right eyes will be directed at (and perceive) different images, giving the viewer an auto-stereoscopic view of the displayed object. Thus, a viewer will experience a 3D perspective view of the image represented by the displayed 2D image array, without the need for visual aids, such as 3D glasses.

In one preferred embodiment of the invention, the image tiles will be retrieved from storage on a memory module for display on the display 110. For example, when operated in “memory mode” a user may initiate a 3D display of the memory contents on the display 110 (e.g. via use of a remote device such as a remote control as will be described in further detail below).

In another preferred embodiment, the image tiles to be displayed on the display 110 will be received by the auto-stereoscopic display apparatus 100 from an outside video source via the video input 150. By way of example, a user may wish to cause the 3D display of images or video not stored on a memory module of the auto-stereoscopic display apparatus 100. As such, the user may choose to input content via the video input 160 using an external content source.

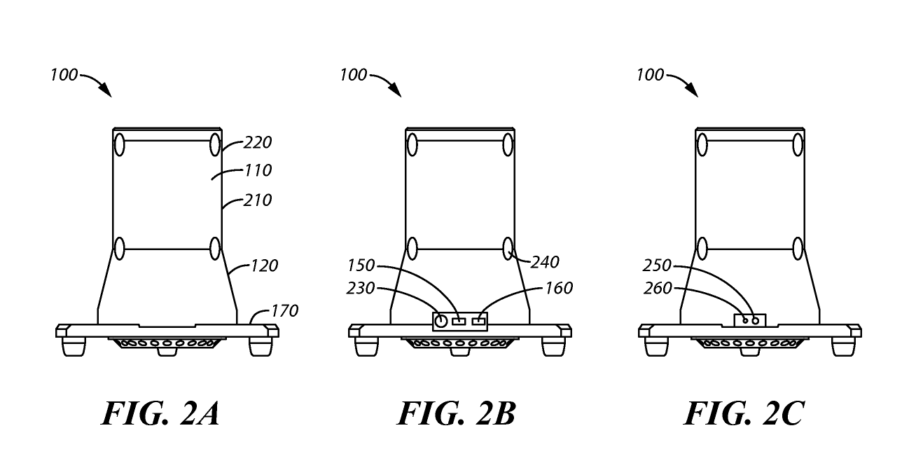

FIGS. 2A-2C illustrate different views of the auto-stereoscopic display apparatus 100, according to some embodiments of the invention. Specifically, FIG. 2A illustrates a front view of the auto-stereoscopic display apparatus 100 together with the front cover 120 and the foot 170. Also illustrated are an acrylic cover 210 and an IR sensor 220.

As illustrated, in some embodiments the display 110 will be enclosed by the acrylic cover 210 that is mechanically cooperated with the auto-stereoscopic display apparatus 100. However, in other embodiments, the display 110 may be encased by a cover of essentially any material composition, or the display 110 may be operated without the use of a cover.

In some embodiments, the auto-stereoscopic display apparatus 100 may be controlled remotely, for example by a remote device (not shown) configured to transmit wireless control commands. By way of example, remote optical signaling by a control device may be received by the IR sensor 220 and used to control the operation of the auto-stereoscopic display apparatus 100 via an electrical connection to the microprocessor.

FIG. 2B depicts a left view of the auto-stereoscopic display apparatus 100 according to some embodiments. Further illustrated in FIG. 2B are: a DC IN socket 230 and security seal 240. In some embodiments, the DC IN socket 230 will analogously correspond to the power input 140 as described with respect to FIG. 1. In some preferred embodiments, the power delivered to the auto-stereoscopic display apparatus 100 will be in the form of a DC current delivered via the DC IN socket 230. However, in other embodiments, the input power to the auto-stereoscopic display apparatus 100 may comprise an AC power signal.

FIG. 2C illustrates the auto-stereoscopic display apparatus 100 according to some embodiments. Specifically, FIG. 2C further illustrates a power switch 250 and a LED indicator 260. In preferred embodiments, the power switch is electrically coupled between the microprocessor (not shown) and the DC IN socket 230 (see FIG. 2B). The LED indicator is also electrically coupled to the DC IN socket 230 and the microprocessor.

In operation, a user may control power to the auto-stereoscopic display apparatus 100 by toggling the power switch 250. Furthermore, the illumination of the LED indicator 260 may indicate one or more states of the auto-stereoscopic display apparatus 100. By way of example, illumination of the LED indicator 260 may indicate a “power on” state of the auto-stereoscopic display apparatus 100.

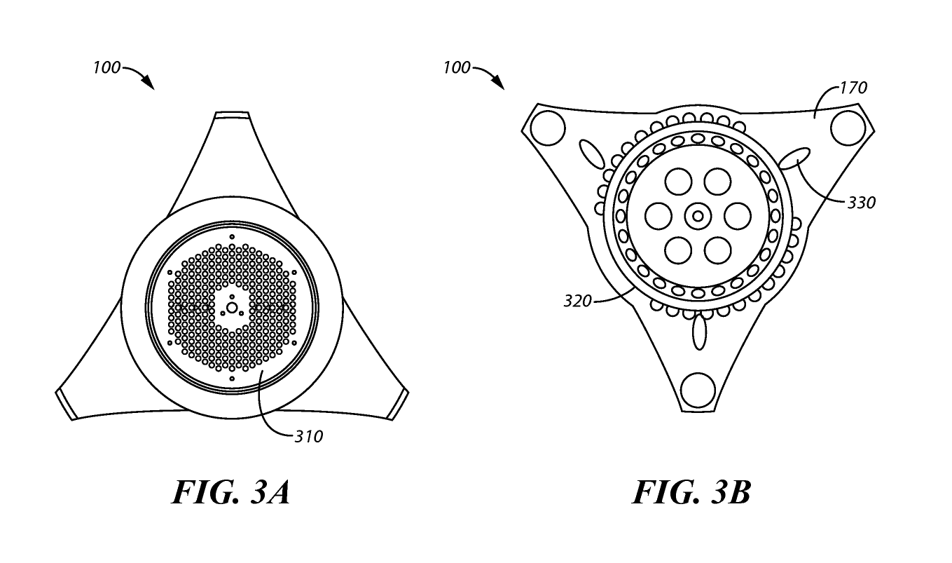

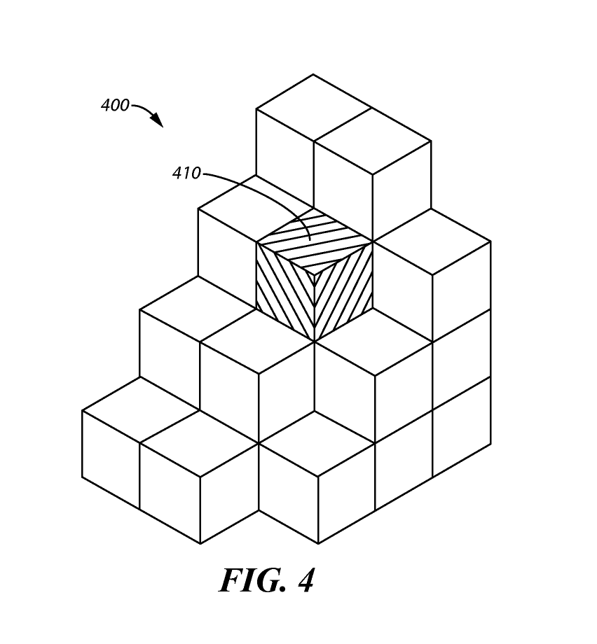

FIGS. 3A and 3B illustrate top and bottom views of the auto-stereoscopic display apparatus 100, respectively. Specifically, FIG. 3A depicts a top cover 310 that is mechanically cooperated with the auto-stereoscopic display apparatus 100. Similarly, FIG. 3B depicts a bottom cover 320 and a bottom security seal 330, wherein the bottom cover 320 and the bottom security seal 330 are both mechanically cooperated with the underside of the foot 170.

FIG. 4 is a traditional illustration of a plurality of voxel elements 400. As illustrated, a single voxel element 410 is highlighted. As would be understood by those of skill in the art, each voxel element may represent a “scatter value” corresponding to a measurement at a particular point on an object in three-dimensional space. By way of example, the single voxel element 410 may represent a measurement value taken at the surface location among the plurality of voxel elements 400.

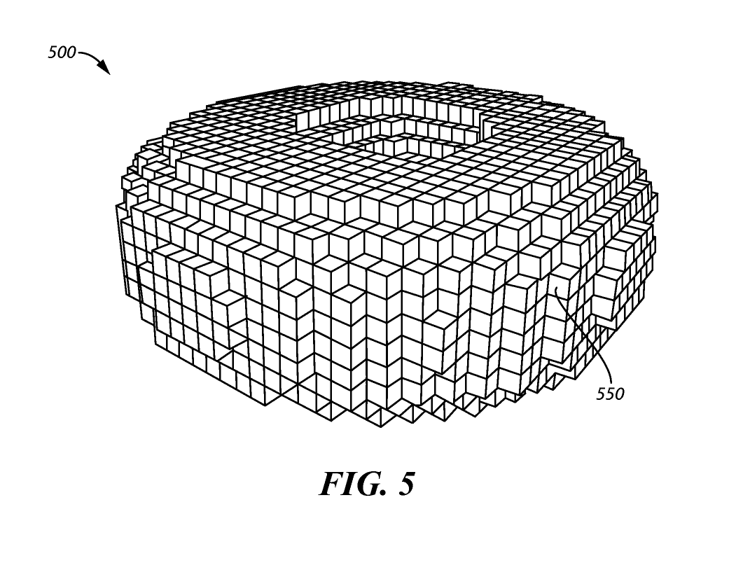

FIG. 5 illustrates another example of a three-dimensional object surface 500 comprising a plurality of individual voxel elements 510. As would be understood by one of skill in the art, each of the individual voxel elements 510 may be used to represent the surface of a corresponding location on a three dimensional object. Thus, information corresponding to each individual voxel element 510 (i.e. each voxel value) may be used to provide data relating to a three dimensional object surface.

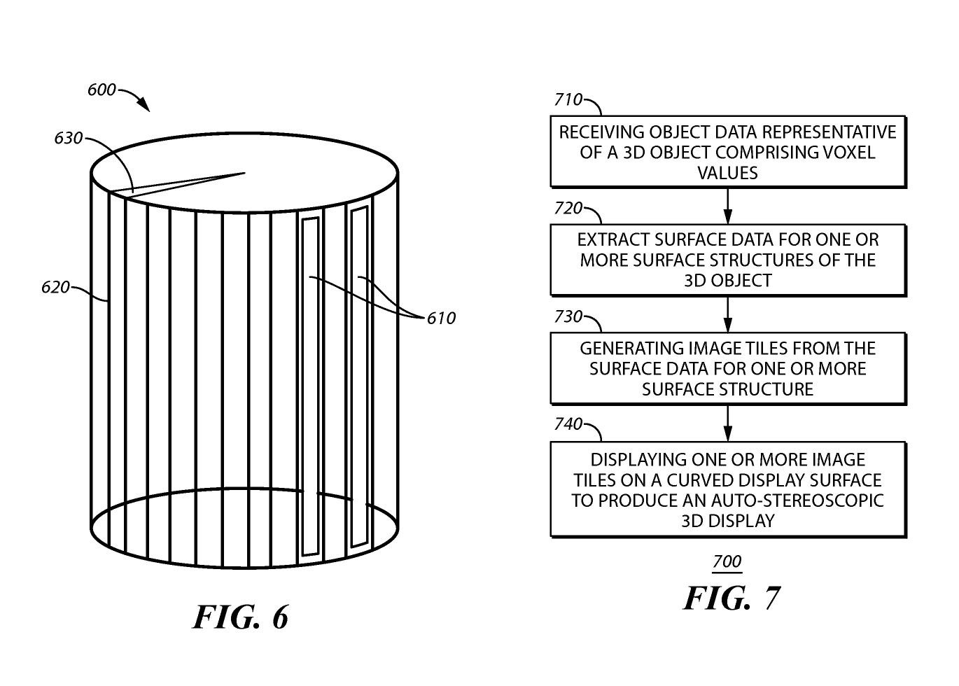

FIG. 6 illustrates an image display 600 according to some embodiments of the present invention. As depicted, the image display 600 comprises a plurality of individual image tiles 610 within display regions 620 and separated by an angular separation 630.

In preferred embodiments of the invention, the individual image tiles 610 will comprise two dimensional image representations of voxel data. By way of example, voxel data generated using a magnetic resonance imaging (MRI) technique may be collected wherein the voxel data corresponds to measurements over one or more three-dimensional object surfaces. Based on the voxel data, a plurality of image tiles may be generated to represent one or more surface projections over the one or more three-dimensional object surfaces. Thus, in preferred embodiments, each image tile of the plurality of image tiles 610 will be representative of an image projection taken at a unique angular viewpoint around one or more three-dimensional object surfaces.

In preferred embodiments, the plurality of image tiles 610 will be displayed to form image display 600, wherein each individual image tile is displayed within a corresponding tile display region 620. As illustrated in FIG. 6, the individual tile display regions are separated by the angular separation 630 around the circumference of the image display 600. Although, the angular separation 630 between the display regions 620 may be essentially any angle, in preferred embodiments the angular separation will be 1 degree. Thus, in preferred embodiments, the plurality of image tiles 610 will total 360 tiles wherein the angular separation is 1 degree, creating a 360 degree display around the image display 600.

In practice, due to the angular separation between each of the plurality of image tiles 610, the displayed image tiles will only be visible within a single one degree field of view; thus a user viewing the image display 600 will perceive different image tiles as between the left and right eyes, creating an auto-stereoscopic effect producing a perception of depth. Additionally, in preferred embodiments the curvature of the image display 600 will aid in the ability to seamlessly present each image tile within a one degree viewing angle such that the displayed object will exhibit a motion parallax quality as the viewer moves around the image display 600. These combined qualities of depth perception and motion parallax are important factors in making a displayed image appear convincing as a 3D volumetric shape, without the need for additional viewing aids such as 3D glasses etc.

FIG. 7 illustrates a flow diagram for a method 700 for use in producing a three dimensional image representation of one or more three dimensional surface structures, according to some embodiments.

The method 700 begins in step 710 in which object data is received by one or more processor based systems, wherein the object data is representative of one or more 3D object surfaces and comprises one or more voxel values. In some preferred embodiments, the

In preferred embodiments, the receiving processor based system may comprise the auto-stereoscopic display apparatus 100, as discussed above with respect to FIG. 1. However, in alternative embodiments, the receiving processor based system may comprise essentially any processor based device capable of carrying out the steps of method 700 as described herein. For example, the processor based system may comprise, but is not limited to, one or more personal computers, workstations, servers or mobile devices etc.

In step 720, surface data corresponding to one or more surface structures will be extracted from the received object data. The subsequent determination of individual surface structures represented in the surface data may occur according to essentially any criteria chosen by the user. By way of example, individual surface structures may be extracted based on correlations between color or frequency components in the extracted surface data. In another example, surface structures may be determined based on information pertaining to the spatial relationships between adjacent points.

In step 730, image tiles are generated from the surface data for the one or more surface structures of step 720. In preferred embodiments, each generated image tile will be representative of a two dimensional image projection of a unique point along the one or more surface structures. By way of example, each generated image tile may correspond to a unique two dimensional representation of a projection of a three dimensional object.

In step 740, the one or more image tiles are displayed on a curved display surface to produce a stereoscopic 3D display. In preferred embodiments, the image tiles may be displayed on a curved display such as display 110 discussed above with respect to FIG. 1. However, the image tiles may be displayed on essentially any curved display capable of creating a stereoscopic effect. When viewed by a viewer, the viewer's left and right eyes will perceive different image tiles (as displayed at different angles) along the curved display, creating an auto-stereoscopic effect such that the user may perceive an image in 3D (with depth) without the need for 3D glasses etc.

In preferred embodiments of the invention, the displayed image tiles will be separated by an angular separation of approximately 1 degree. For example, 360 unique image tiles may be displayed with a 1 degree separation around a curved display, such as the display 110. Thus, when viewed at any angle by a user, each displayed tile will only be visible within a singe degree field of view and the display 110 will appear to project a 3D representation of the object surface represented by the plurality of displayed image tiles. However, in other embodiments, the angular separation between image tiles, as well as the number of image tiles displayed may be either increased or decreased according to the particular display utilized.

The present invention has been described above in terms of a presently preferred embodiment so that an understanding of the present invention can be conveyed. There are, however, many configurations for the system not specifically described herein but with which the present invention is applicable. The present invention should therefore not be seen as limited to the particular embodiments described herein, but rather, it should be understood that the present invention has wide applicability with respect to auto-stereoscopic displays generally. All modifications, variations, or equivalent arrangements and implementations that are within the scopes of the attached claims should therefore be considered within the scope of the invention.

1. An auto-stereoscopic display apparatus comprising:
a curved display surface disposed around a curved outer surface, the curved display surface comprising a plurality of light emitting elements;
a plurality of light emitting elements, wherein the plurality of light emitting elements are grouped into a plurality of tiles
a microprocessor electrically coupled to the plurality of light emitting elements; and
wherein the microprocessor is configured to cause the display of at least two images on at least two of the plurality of tiles to produce a plurality of image tiles.

2. The auto-stereoscopic display apparatus of claim 1, wherein each of the plurality of image tiles are disposed around the curved display surface at a different angular position.

3. The auto-stereoscopic display apparatus of claim 2, wherein any two adjacent image tiles of the plurality of images tiles have a one degree separation in angular position.

4. The auto-stereoscopic display apparatus of claim 2, wherein any two adjacent image tiles of the plurality of image tiles have a less than a one degree separation in angular position.

5. The auto-stereoscopic display apparatus of claim 1, wherein each one of the plurality of images is representative of a two-dimensional projection of at least a portion of a three-dimensional surface.

6. The auto-stereoscopic display apparatus of claim 1, wherein the plurality of image tiles produce a three-dimensional image representation of a three-dimensional surface.

7. The auto-stereoscopic display apparatus of claim 1, wherein each one of the plurality of images is representative of one or more voxel values.

8. The auto-stereoscopic display apparatus of claim 1, wherein each one of the plurality of images is representative of magnetic resonance imaging (MRI) data.

9. The auto-stereoscopic display apparatus of claim 1, wherein the display of the plurality of images on the plurality of image tiles forms a three dimensional (3D) image.

10. A method of forming a three-dimensional image comprising:
receiving object data representing a three-dimensional object, wherein the object data comprises a plurality of voxel values;
extracting surface data from the received object data wherein the surface data represents one or more surface structures of the three dimensional object;
generating a plurality of image tiles from the surface data for each of the one or more surface structures of the three-dimensional object, and
displaying one or more of the image tiles for one or more of the surface structures, wherein the displaying further comprises displaying the one or more of the images tiles around a curved display surface.

11. The method of claim 10, further comprising:
displaying two or more of the plurality of image tiles on the curved display surface, wherein each of the displayed image tiles is located at a different angular position.

12. The method of claim 11, wherein any two adjacent image tiles of the displayed image tiles, have a one degree separation in angular position.

13. The method of claim 11, wherein any two adjacent image tiles of the displayed image tiles, have a separation of less than one degree in angular position.

14. The method of claim 10, wherein each image tile comprises a two-dimensional image projection representing at least a portion of at least one surface structure.

15. The method of claim 10, wherein each of the plurality of images tiles is different from the other of the plurality of image tiles.

16. The method of claim 10, wherein each of the plurality of voxel values corresponds to a scattering measurement.

17. The method of claim 10, wherein the plurality of voxel values corresponds to magnetic resonance imaging data.

18. The method of claim 10, wherein the extracting step further comprises:
grouping two or more of the voxel values based, on frequency component to produce the surface data.

19. The method of claim 10, wherein the extracting step further comprises:
grouping two or more of the voxel values based at least in part on position information.

20. The method of claim 10, wherein the generating the plurality of image tiles step further comprises:
creating multiple projections of the one or more surface structures, wherein each of the plurality of image tiles corresponds to one projection.
